(19) United States
(12) Patent Application Publication
(10) Pub. No.: US 2014/0361553 A1
(43) Pub. Date: Dec. 11, 2014

(54) BULLET CATCH ASSEMBLY

(71) Applicant: Sale Builders Hardware Ltd. (DBA Better Home Products, Ltd.), South San Francisco, CA (US)

(72) Inventor: Kenneth Martin Sale, Jr., San Francisco, CA (US)

(21) Appl. No.: 13/911,760

(22) Filed: Jun. 6, 2013

(51) Int. Cl. E05C 1/00

(52) U.S. Cl. CPC E05C 1/002
USPC 292/164; 292/147

(57) ABSTRACT

A door catch mechanism includes a housing that has a generally cylindrical body having an outer surface of a first diameter, a first end and a second end, a flange located on the first end of the body, the flange having an outer diameter greater than the first diameter of the body, a first bore formed within the housing and a shoulder forming a floor of the first bore, the shoulder including a hole there through. The housing also has a plurality of longitudinal vanes formed on the outer surface of the body, each vane being formed lengthwise along a portion of the outer surface of the body between the flange and the second end of the body opposite the flange, each vane being tapered from a smaller height to a larger height when traversing the outer surface of the body from the second end toward the first end of the housing. The mechanism further includes a detentable bullet catch mechanism retainably installed within the bore of the housing such that a bullet head of the detentable bullet catch mechanism protrudes beyond the first surface of the housing and is detentable into the housing.

### BACKGROUND

1. Field of the Disclosure

The present disclosure relates to a door catch mechanism, and more particularly, to a bullet catch mechanism.

2. Description of Related Art

A Bullet Catch is generally used as a soft latching mechanism for an entry door or a cabinet door. The mechanism usually includes a recessed “catch” portion, such as a striker plate with a recessed groove, and a bullet detent “engaging” mechanism. The “catch” mechanism is usually installed on a door-jam structure, while the detent engaging mechanism is usually installed in the door itself. In operation, when the door is closed from an open position, the bullet detent in the engaging mechanism is pushed inward against a spring as the bullet engages the catch, and when the bullet engages the recessed groove in the catch mechanism, the spring forces the bullet outward to engage the recess and retain the door in the closed position. The operation is reversed when the door is opened. It is noted that a Ball Catch device is similar to the Bullet Catch, with one difference being that the detent engaging portion is shaped like a ball rather than being oblong like a bullet.

It is common to install bullet/ball catch devices into doors by boring a hole in the door and installing the device in the hole. Both slip fits and slight interference fits are used, with the latter forming a tight (slight interference) fit between the interior of the hole in the door and the outer circumference of the bullet catch housing.

Some interference fit devices are known to merely have a smooth cylindrical housing body that is installed into the bore with an interference fit by driving (e.g., hammering) the device into the hole, with the wood of the door giving somewhat to allow the device to be driven into the hole. These devices, however, are often difficult to remove in the event of a failure of the mechanism due to wear and tear over time.

Some devices have also been known to use a slip-fit between the hole and the housing, and these devices employ a mounting flange that attaches the device to the door using screws so that the device will not slide out of the door. While this type of device is easy to install and remove for replacement by simply removing the screws, it requires that the door be mortised in order to recess and screw the flange into the door.

Another type of prior art device includes recessed grooves about the outer circumference of the housing. This type of device allows the installer to apply an adhesive that fills the recessed grooves to retain the device in the door. This type of device may utilize a slight slip fit or an interference fit, but requires an adhesive in order to retain the device in the door. The need for an adhesive, however, makes it difficult to remove the device when a replacement is required.

Another prior art device, although not a bullet/ball catch per se, but rather, a flat-headed magnetic catch mechanism, includes threads about the circumference of the housing so that the device can be screwed into the hole of the door. This type of attachment is not readily conducive for a bullet/ball catch, however, since a screw head is required on the magnetic catch and such is not practicable with a bullet/ball catch.

One of the more common Bullet/Ball catch devices in use today utilizes a sleeve, separate from the bullet catch mechanism itself, with a raised spring-type engaging member on its outer circumference. When the sleeve and catch mechanism are installed in the bore together, the raised engaging members bend to form a tight fit with the hole in the door. Additionally, the ends of the raised engaging members hold the detent mechanism within the sleeve. This type of device, however, requires additional parts that can make it more expensive, and it also makes it difficult to remove for replacement.

### SUMMARY

The present invention aims to address the foregoing problems by providing a bullet/ball catch mechanism with a housing that is easy to install and subsequently remove if needed, but yet provides a tight fit at final installation. Specifically, the present disclosure relates to door catch mechanism in which a housing has a generally cylindrical body having an outer surface of a first diameter, a first end and a second end, a flange located on the first end of the body, the flange having an outer diameter greater than the first diameter of the body, a first bore formed within the housing and a shoulder forming a floor of the first bore, the shoulder including a hole there through. The housing also has a plurality of longitudinal vanes formed on the outer surface of the body, each vane being formed lengthwise along a portion of the outer surface of the body between the flange and the second end of the body opposite the flange, each vane being tapered from a smaller height to a larger height when traversing the outer surface of the body from the second end toward the first end of the housing. The mechanism has a detentable bullet catch mechanism retainably installed within the bore of the housing such that a bullet head of the detentable bullet catch mechanism protrudes beyond the first surface of the housing and is detentable into the housing.

Thus, upon installation, a slight slip-fit is provided for between the hole diameter and the outer diameter of the housing so that the housing can readily fit into the hole. As the housing is driven into the hole, the vanes engage the surface of the hole to form a tight fit that increases in pressure as the housing continues its inward travel during the drive-in process. Upon final positioning, each vane forms a tight fit with the hole to retain the device. The vanes also provide an anti-torque effect so that, when the bullet detent is rotated to adjust its exerted force, the housing will not rotate within the hole. The device is also easy to remove and replace since the interference fit is between the small vanes and the wood of the hole, rather than between the entire outer surface of the device and the hole.

### BRIEF DESCRIPTION OF THE DRAWINGS

FIG. 1 is a perspective view of one embodiment of a bullet catch mechanism according to the present disclosure.

FIG. 2 is an expanded view depicting component parts of one embodiment of a bullet catch mechanism according to the present disclosure.

FIG. 3 is a cross-sectional view of one embodiment of a bullet catch mechanism according to the present disclosure.

FIG. 4 is a side view of one embodiment of a bullet catch mechanism according to the present disclosure.

FIG. 5 is a top view of one embodiment of a bullet catch mechanism according to the present disclosure.

FIG. 6 is a bottom view of a bullet catch mechanism according to the present disclosure.

FIG. 7 is a cross-sectional view of a housing according to one embodiment of a bullet catch mechanism according to the present disclosure.

FIG. 8 is a detail view depicting the general shape of a vane on the housing of FIG. 7.

FIG. 9 depicts a perspective view of the bullet catch mechanism of the present disclosure and a catch/striker plate that the bullet catch engages.

### DETAILED DESCRIPTION

The following description will be made with reference to the accompanying drawings. It is to be understood that the following description is made with reference to one or more embodiments of the claimed invention, although any number of modifications and other embodiments are intended to be applicable to the claims herein below without departing from the spirit or scope of the invention.

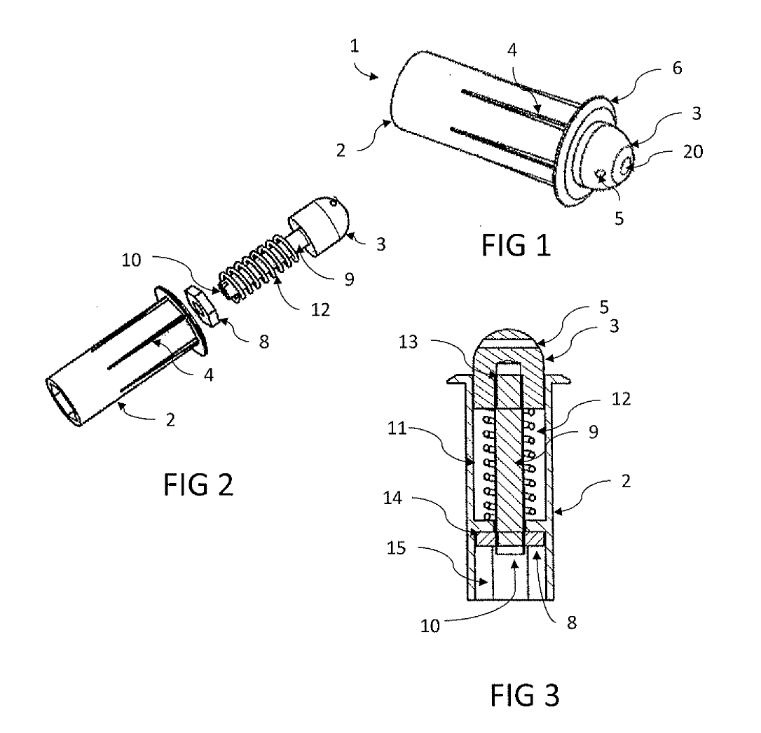

Referring to FIG. 1, depicted therein is a perspective view of one embodiment of a bullet catch mechanism 1 of the present disclosure. FIG. 2 is an expanded view depicting component parts of a bullet catch mechanism according to the present disclosure. As seen in FIGS. 1 and 2, the bullet catch mechanism 1 includes a housing 2, which includes a flange 6. The housing 2 preferably has a generally cylindrical outer shape and includes on its outer periphery a plurality of vanes 4, which will be described in more detail below. The bullet catch mechanism also includes a bullet head 3, which is connected to a threaded rod 9. A nut 8 is engaged and screwed on to threaded rod 9 and one end 10 of threaded rod 9 is mechanically deformed after installation of nut 8 so as to retain nut 8 on threaded rod 9. A spring 12 is installed around threaded rod 9 so as to allow the threaded rod 9 and bullet head 3, as an assembly, to detent into the housing 2 when pressure is applied to the head 3, and to also retain the rod/head assembly in an extended position when pressure is not applied to the rod/head assembly. The assembly of the component parts will now described with reference to FIG. 3.

FIG. 3 is a cross-sectional view of the bullet catch mechanism according to the present disclosure. In FIG. 3, housing 2 contains a bullet detent assembly that is comprised of bullet head 3, threaded rod 9, spring 12 and nut 8. Threaded rod 9 is fixedly engaged with bullet head 3 so that rod 9 does not turn relative to head 3. Bullet head 3 includes a blind hole 13 into which threaded rod 9 is inserted. Here, one end of threaded rod 9 may be pressure fit (interference fit) into blind hole 13. In this case, bullet head 3 may be heated to expand the size of blind hole 13 and threaded rod 9 may be cooled to reduce the diameter of rod 9, and the two components may then be assembled so that, upon both parts reaching room temperature, an interference fit is formed between them and rod 9 is fixedly engaged to bullet head 3. In another aspect, rod 9 may simply be manually forced into blind hole 3, and an adhesive may be used to retain the rod in hole 13. With the use of a pressure fit between the component parts, it can be understood that threaded rod 9 is not threaded along its entire length, but rather, may be threaded only partially along its length from the end which engages nut 8. That is, a portion of the end of rod 9 that engages the bullet head is not threaded, but rather, is merely a solid cylindrical surface. As an alternative, rod 9 may be threaded along its entire length, and blind hole 13 may also be a threaded hole. In one embodiment, the rod may be an M5-0.8 metric size threaded rod and blind hole 13 may be a corresponding M5 internal thread. In this case, rod 9 is screwed into hole 13 and use of a thread locking compound may be employed so that rod 9 will be fixedly engaged with bullet head 3. Regardless of the technique employed, it is preferable that rod 9 and bullet head 3 are fixedly engaged with one another so as to more or less form a single unit.

Referring to FIGS. 2 and 3, bullet head 3 is seen to be formed with a cylindrical portion and an integrally formed spherical head portion. The end of the cylindrical portion is relatively flat and blind hole 13 is formed in the center of the flat end. The spherical head portion includes a small, relatively flat surface 20 on its outermost tip. This small flat surface 20 of the bullet head is for engaging with a flat surface 22 of the bottom of a recessed catch bowl 23 in catch/striker plate 21 that is installed on the door-jam and to which the bullet catch engages to hold the door closed. (See FIG. 9). Bullet head 3 is also seen to include a through-hole 5 through the spherical portion. Through-hole 5 may be about 1 mm in diameter and as will be described below, may be used for adjusting the amount of protrusion of the bullet head assembly from the housing 2.

Once bullet head 3 and rod 9 have been fixedly engaged to form a single unit, a spring 12 is installed around rod 9. Spring 12 preferably has an 8 mm outer diameter and is formed with a 1 mm wire. The length of the spring and the compression ratio is chosen to provide a tensile force when the bullet head assembly is fully extended (to be described below), and to not require an excessive force to compress the bullet head assembly inward into the housing when the bullet head assembly is compressed inward. Once spring 12 has been installed over rod 9, the assembly is inserted into a cylindrical bore 11 within housing 2. Bore 11 is sized so as to form a slight slip fit between its inner diameter and the outer diameter of the cylindrical portion of bullet head 3 so as to allow the bullet head assembly to slide freely in an out of the housing 2. The end of rod 9 opposite the bullet head 3 is inserted through a hole 16 in a shoulder 14 of the housing 2.

The bullet head/rod/spring assembly is inserted into housing 2 so that the threaded end of rod 9 opposite the bullet head protrudes through hole 16 in housing 2 and into a hexagonal shaped bore 15 in housing 2. A nut 8, which is preferably a 12 mm×2.5 mm nut, with M5 internal threads, is inserted into the hexagonal shaped bore 15. Here, hexagonal bore 15 is formed with a size so as to provide a slight slip fit between its internal surfaces and the outer surfaces of nut 8. The threaded end of rod 9 is inserted and screwed into the threads of nut 8 so that the end of rod 9 protrudes through nut 8. In this regard, the bullet head/rod assembly may be turned using a tool inserted into through-hole 5 of the bullet head so as to turn the bullet head/rod assembly to screw the assembly into nut 8. Once the bullet head/rod assembly has been inserted so the threaded end of rod 9 protrudes through nut 8, the bullet head/rod assembly is compressed into housing 2 so that the protruding threaded end of rod 9 extends outside of the hexagonal shaped bore 15 of housing 2. At this point, the protruding threaded end of rod 9 is deformed (See. Ref 10, FIG. 6) using a compression-deformation technique so that the deformed end portion 10 of rod 9 has an interference fit with the threads of nut 8 and rod 9 will no longer freely thread through the inner threads of nut 8. The deformed end 10 of rod 9 forms a stop mechanism that, when the bullet head/rod assembly is turned to extend the bullet head outward of housing 2, the stop engages the nut to prevent the bullet head/rod assembly from further extension.

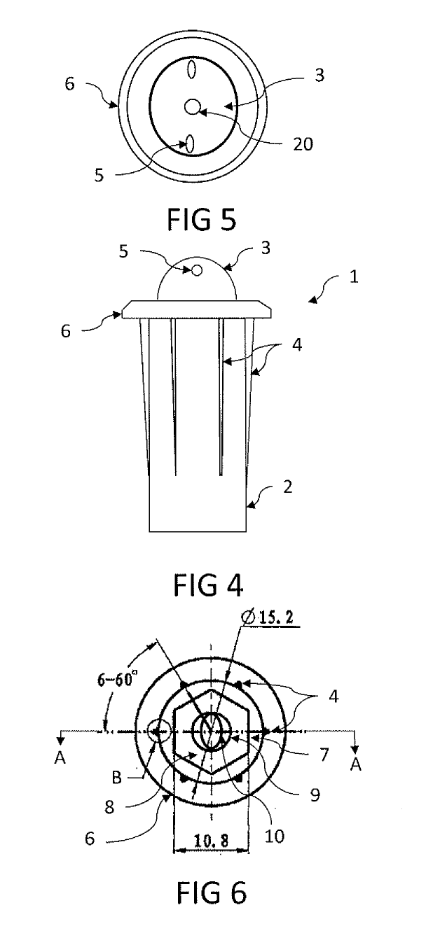

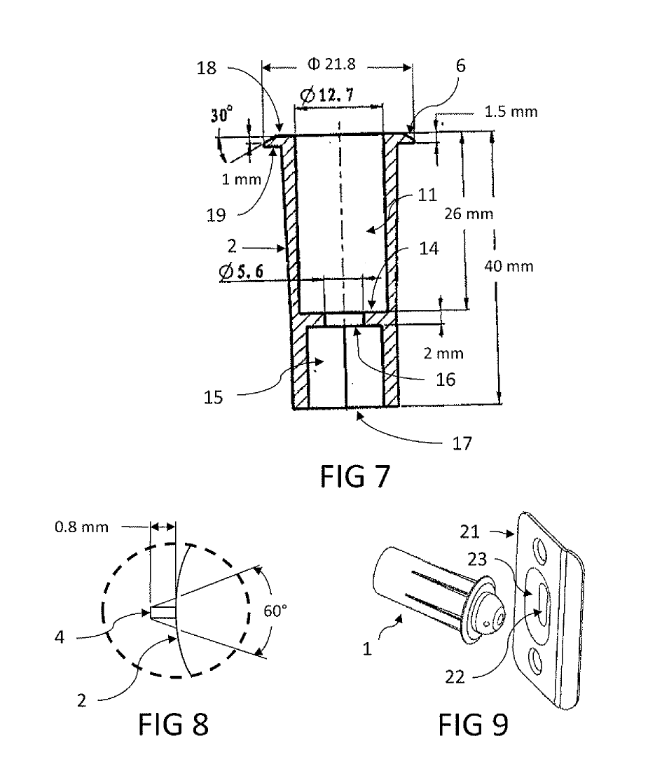

FIG. 4 depicts a side view and FIG. 5 depicts a top view of a bullet catch mechanism according to the present disclosure. In FIGS. 4 and 5, housing 2 is seen to include a plurality of vanes 4 and a flange 6. The vanes 4 will be described in more detail below. As for flange 6, it is seen to be integrally formed on one end of housing 2 and is generally circular in shape and larger in diameter than that of housing 2. While flange 6 is depicted as being circular in shape in the figures, it can be understood that other shapes (e.g., square, triangular, etc.) may be employed instead. Moreover, although flange 6 is depicted as being integrally formed on housing 2, it may be a separate element that is attached to the housing (e.g., screwed on, welded, etc.) In one embodiment, the outer diameter of flange 6 may be about 21.8 mm, and its thickness may be about 1.5 mm. Flange 6 is also depicted with a chamfer or rounded-over edge on its outermost edge, although a chamfer or round-over is not necessarily required. In one embodiment, the chamfer may be about 30 degrees as seen in FIG. 7. A shoulder surface 19 of flange 6 engages a surface of a door when the bullet catch assembly is installed in a hole in the door.

FIG. 6 is a bottom view of a bullet catch mechanism and FIG. 7 is a cross-sectional view of housing 2 taken along line A-A in FIG. 6. In the figures, housing 2 is seen to be formed as a single unit, and is preferably formed by a die casting method using a zinc alloy material. Of course, die casting is not necessarily required and the housing may be manufactured via other methods, such as machining, molding, lithography, etc. and may be made of other materials instead of a zinc alloy. In one embodiment, housing 2 is formed to be generally cylindrical shaped with an outside diameter of about 15.2 mm and overall length of about 40 mm. As described above, flange 6 is integrally formed on housing 2 with the dimensions discussed above. Internally, housing 2 is formed with a cylindrical bore 11 from the flange end face 18 of the housing to a shoulder 14. In one embodiment, the bore 11 is formed to be about 12.7 mm in diameter and about 26 mm in depth from the surface 18 of flange 6 to shoulder 14. Shoulder 14 is formed to be about 2 mm thick and has a through-hole 16 formed therein at a diameter of about 5.6 mm.

Formed in an end 17 of housing 2 is a hexagonal shaped bore 15. Hexagonal shaped bore 15 may be formed to be about 10.8 mm across its opposing side surfaces and about 12 mm deep. Of course, bore 15 is formed in a hexagonal shape to coincide with the use of a hex nut 8, but it can readily be understood that other shapes may be used instead, so long as it is formed to accommodate a nut or other type of retaining device used to retain the bullet head/rod assembly with the mechanism.

Housing 2 also has a plurality of integrally formed vanes 4 along its outer surface. In FIG. 6, six vanes 4 are seen to be formed at 60 degrees apart from one another. While six vanes are depicted in the figures, it can be understood that more or less vanes can be employed instead. Referring to FIG. 4, it can be seen that the vanes 4 are tapered along the length of the housing 2. That is, as shown in the figures, vanes 4 taper in a generally triangular manner from a size roughly equal to the outer diameter of housing 2 nearest end 17 to a larger size at the intersecting surface 19 with flange 6. That is, vanes 4 are generally formed in a triangular shape lengthwise along the outer surface of the housing 2 as viewed from a side view of the housing. This triangular shape along the length of the housing can be generally seen in FIG. 4. A more detailed view of vanes (Detail view B of FIG. 6) is depicted in FIG. 8.

Referring to FIG. 8, a vane 4 is shown to be formed approximately 0.8 mm in height nearest its intersection with the surface 19 of flange 6, and as one traverses the vane along the length of the housing away from surface 19 toward end 17 of the housing, the height of vane 4 tapers down from the about 0.8 mm to be roughly equal to the outer diametrical surface of the housing 2. Additionally, vane 4 is seen, from an end 17 viewpoint of the housing 2 (i.e., the viewpoint of FIG. 6), to be formed with a generally pyramidal cross sectional shape formed at a 60 degree angle.

While the drawings depict vanes 4 as being triangular in shape, different variations in the shape may be employed instead. For instance, rather than being triangular, vanes 4 may be formed with a curved profile so as to increase in height lengthwise when traversing across the surface of housing 2 from end 17 toward end 18. In addition, while vanes 4 are shown as being connected with flange 6 at their intersection, it can be understood that the vane may terminate before the flange so as to form a gap between the end of the vane 4 and the surface 19 of flange 6. Further, while vanes 4 are depicted as commencing at a point between end 17 and flange surface 19 along the outer surface of housing 2, it can be understood that vanes 4 may commence near or equal to surface 17 of housing 2. Moreover, any combination of the foregoing may employed. For example, two opposing vanes 4 may be as shown in the figures and connect with flange surface 19, while two other vanes may be formed with a gap between the end of vane 4 and flange surface 19, and two other vanes 4 may be formed in yet a different manner. Further yet, any alternative profile rather than a pyramidal shape may be used instead (e.g., curved profile as seen from FIG. 8 rather than a 60 degree pyramid).

In installing the bullet catch mechanism for operation, a hole is formed in a door. The hole is preferably about 15.875 mm (⅝ inch) so as to allow the bullet catch mechanism to be inserted into the hole with an initial slight slip fit. As the bullet catch mechanism is inserted into the hole in the door, the vanes 4 will start to form an interference fit with the hole in the door, and the bullet catch mechanism is then driven into the hole so that the vanes deform the wood in the door and form a tight fit to retain the bullet catch mechanism in the door. The bullet catch mechanism is driven into the hole in the door until the surface 19 of flange 6 engages the surface of the door. At this point, the bullet catch mechanism is fully installed and retained in the door via the interference fit with the vanes.

The arrangement of the bullet catch mechanism also allows for fairly easy removal and replacement, if necessary, due to, for example, wear and tear of the mechanism over time. In particular, a tool may be inserted into through-hole 5 in the bullet head so that a pulling force may be exerted on the bullet catch mechanism. The pulling force can loosen the tight fit between the vanes and the wood and as the mechanism begins to be removed from the hole in the door, the tapered shape of the vanes allows for the mechanism to become looser and eventually disengage from the door. If a replacement bullet catch is necessary, the new bullet catch can simply be rotated to a point where the vanes of the new mechanism will engage the hole in the door at an offset angle (for example, 30 degrees) from the location where the prior mechanism was installed. This provides the ability to insert a new mechanism without the need to replace the entire door. Thus, the mechanism of the present disclosure provides for easy installation and removal as compared with the prior art devices.

The catch/striker plate 21 is installed on the door jam/frame so that the center of the catch bowl 23 is aligned with the center of the bullet catch mechanism. Once both the catch/striker plate 21 and the bullet catch mechanism 1 are installed, the protrusion of the bullet head from the housing 2 can be adjusted. In particular, a tool may be inserted into the through-hole 5 of the bullet head 3 and the bullet head/rod assembly can be rotated using the tool to either extend the amount of protrusion or to retract the amount of protrusion. In this manner, the amount of protrusion, and the amount of tensile force exerted by the spring 12 when the bullet head is detented inward when the door is closed can be adjusted to fit the needs of the user.

While the mechanism of the present disclosure has been described with reference to particular embodiments, it is readily understood that various alternative arrangements and variations may be used instead without departing from the spirit and/or scope of the invention.

What is claimed is:

1. A door catch mechanism, comprising:
a housing comprising:
a generally cylindrical body having an outer surface of a first diameter, a first end and a second end;
a flange located on the first end of the body, said flange having an outer diameter greater than the first diameter of the body;
a first bore formed within the housing;
a shoulder forming a floor of the first bore, said shoulder including a hole there through; and
a plurality of longitudinal vanes formed on the outer surface of the body, each said vane being formed lengthwise along a portion of the outer surface of the body between the flange and the second end of the body opposite the flange, each said vane being tapered from a smaller height to a larger height when traversing the outer surface of the body from the second end toward the first end of the housing; and
a detentable bullet catch mechanism retainably installed within the bore of the housing such that a bullet head of the detentable bullet catch mechanism protrudes beyond the first surface of the housing and is detentable into the housing.

2. The door catch mechanism according to claim 1, wherein the plurality of vanes comprises six vanes.

3. The door catch mechanism according to claim 1, wherein each vane is tapered in a triangular shape lengthwise along the outer surface of the housing.

4. The door catch mechanism according to claim 3, wherein each vane tapers from a size approximately equal to the outer surface of the housing to a size less than the outer diameter of the flange.

5. The door catch mechanism according to claim 3, wherein each vane commences partially along the length of the outer surface of the housing between the first and second ends, and extends to a surface of the flange opposite said first surface of the housing.

6. The door catch mechanism according to claim 1, wherein each vane has a generally pyramidal profile in a circumferential direction about the housing.

7. The door catch mechanism according to claim 1, wherein the detentable bullet catch mechanism is spring loaded to retain the bullet head of the detentable bullet catch mechanism in an outward position.

8. The door catch mechanism according to claim 1, wherein the detentable bullet catch mechanism is adjustable so as to adjust the amount of protrusion of the bullet head beyond the first surface of the housing.

9. The door catch mechanism according to claim 8, wherein the bullet head has a hole there through, and the detentable bullet catch mechanism is adjustable by rotating the bullet head about an axis extending along the length of the housing using said hole in the bullet head.

10. The door catch mechanism according to claim 1, wherein the housing further comprises a second bore, wherein said shoulder separates said first bore from said second bore, and a surface of the shoulder opposite the floor of the first bore forms a floor of the second bore.

11. The door catch mechanism according to claim 10, wherein the first bore is cylindrical in shape and the second bore is hexagonal in shape.

12. The door catch mechanism according to claim 1, wherein the detentable bullet catch mechanism comprises:
the bullet head;
a threaded rod connected with the bullet head;
a spring; and
a nut connected with the threaded rod.

13. The door catch mechanism according to claim 11, wherein the detentable bullet catch mechanism comprises:
the bullet head;
a threaded rod connected with the bullet head;
a spring; and
a nut connected with the threaded rod,
wherein the bullet head, threaded rod connected thereto and the spring are installed in the first bore,
wherein the threaded rod extends through the hole in the shoulder into the second bore, and
wherein the nut is installed in the second bore and is threadedly engaged with the threaded rod extending into the second bore.

14. The door catch mechanism according to claim 13, wherein an end of the threaded rod extending through the nut is deformed so that the nut is retained on the threaded rod by the deformed end.

15. The door catch mechanism according to claim 14, wherein the nut is hexagonal shaped, and the hexagonal shape of the second bore prevents an angular displacement of the nut about an axis of the length of the threaded rod.
